(19) United States
(12) Patent Application Publication
(10) Pub. No.: US 2008/0032737 A1
(43) Pub. Date: Feb. 7, 2008

(54) Wireless presentation apparatus

(75) Inventors: Liang-Yi Liu, Taipei City (TW); Chun-Hsin Liu, Banciao City (TW); I-Ming Chou, Taipei City (TW); Chien-Chung Chien, Banciao City (TW); Kuo-Wei Yang, Sincheng Township (TW)

Correspondence Address: ROSENBERG, KLEIN & LEE, 3458 ELLICOTT CENTER DRIVE-SUITE 101, ELLICOTT CITY, MD, 21043, US

(73) Assignee: Lite-On Technology Corporation

(21) Appl. No.: 11/498,734

(22) Filed: Aug. 4, 2006

(51) Int. Cl. H04M 1/00

(52) U.S. Cl. 455/556.1

(57) ABSTRACT

A presentation apparatus includes a power management module, a storage unit, an amplifier amplifying an audio signal based on an audio control signal, a socket receiving the amplified audio signal from the amplifier, a detection circuit, a plurality of buttons, a wireless receiver/transmitter and a processing chip which connects with the power management module, the storage unit, the amplifier, the detection circuit, the buttons, the wireless receiver/transmitter to control the movement of a cursor, receive/transmit an audio signal, output the audio control signal, and determine the type of plug plugged into the socket according to the detection circuit connecting with the socket.

### BACKGROUND OF THE INVENTION

1. Field of the Invention

The present invention relates to a wireless presentation apparatus, and more particularly to wireless presentation apparatus integrating various functions, such as communicating via a web phone, bluetooth communication, control of a mouse, indication utilizing a laser beam, voice amplification utilizing a hands free megaphone, and receiving or broadcasting stereophonic signals.

2. Description of the Prior Art

With the development of wireless communication, many application products have been produced for users. These application products include electronic devices, such as web phones, laser indicators, presentation apparatuses, wireless mice, etc. However, these products are not integrated, so they are cumbersome and inconvenient for a user to carry around or use. Thereof, some electrical devices integrating various functions have gradually been developed, for example, presentation apparatuses integrated with laser indicators.

However, the above described presentation apparatuses only include laser indicators and do not satisfy users' requirements as users must simultaneously use cursors controlled via a computer mouse and communicate with others during briefings or meetings. Such users communicate with others using earphones, megaphones or headsets during a briefing or meeting, yet because each of these devices is connected via a corresponding plug, which are subsequently plugged into corresponding sockets of a computer or presentation apparatus, the devices cause inconvenience. Moreover, it is expensive to manufacture the above described presentation apparatuses due to the number of plugs and corresponding sockets that are required for each device.

### SUMMARY OF THE INVENTION

The first object of the present invention is to integrate various functions, such as web phone communication, Bluetooth communication, mouse movement, a laser indicator, a hands free megaphone, the receiving and transmitting of stereophonic signals, etc. for further filling users' demands.

The second object of the present invention is to communicate via only one socket that supports the plugs of various communication devices, such as an earphone, a megaphone or an earphone with a microphone, for further simplifying the circuitry of the wireless presentation apparatus and decreasing costs.

The third object of the present invention is to detect and determine the type of a plug plugged into the socket of the wireless presentation apparatus, via the detection circuit and the socket.

In order to achieve the above objects, the present invention provides a wireless presentation apparatus that includes a battery, a power management module connecting with the battery, a laser indicator connecting with the power management module, a storage unit storing application programs, a processing chip connecting with the power management module and storage, an amplifier connecting with a processing chip, a socket connecting with the amplifier, a detection circuit connecting with the socket, a plurality of buttons connecting with the processing chip, and a wireless receiver/transmitter connecting with the processing chip. In this case, the processing chip determines the type of the plug plugged into the socket via the detection circuit and controls the movement of a cursor, receives or transmits sounds and outputs an audio control signal, and the amplifier receives the audio control signal to output an amplified audio signal.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The above and further advantages of this invention may be better understood by referring to the following description, taken in conjunction with the accompanying drawings, in which:

FIG. 1 is a diagram of the exterior of the present invention;

FIG. 2 is a diagram of the laser indicator of the present invention;

FIG. 3 is a diagram of the wireless communication system of the present invention;

FIG. 4 is a diagram of the first embodiment of the present invention;

FIG. 5 is a detailed circuit diagram of the power management module of the present invention;

FIG. 6˜6A are detailed circuit diagrams of the processing chip connecting with the storage unit, of the present invention; and

FIG. 7 is a detailed circuit diagram of the detection circuit connecting with the socket, of the present invention.

The drawings will be described further in connection with the following detailed description of the present invention.

### DETAILED DESCRIPTION OF THE PREFERRED EMBODIMENTS

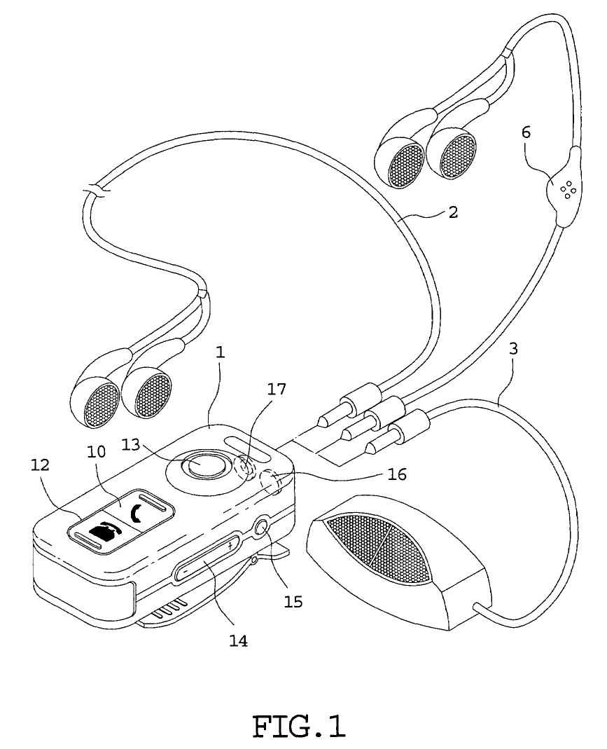

Referring to FIG. 1, a diagram of the exterior of the present invention is shown. A wireless presentation apparatus 1 connects with a remote electronic device and includes a mouse 13, a button switch 15, a laser indicator 16, a socket 17, and a plurality of buttons. An earphones plug 2, a megaphone plug 3 or a communication plug 6, plugs into the socket 17. The plurality of buttons are respectively a communication key 10, a power/connection key 12, and a function key 14. The mouse 13 is used to move the cursor on the electronic device (which is not shown) and start the functions. Users press the button switch 15 to drive the laser indicator 16 to emit the laser beam.

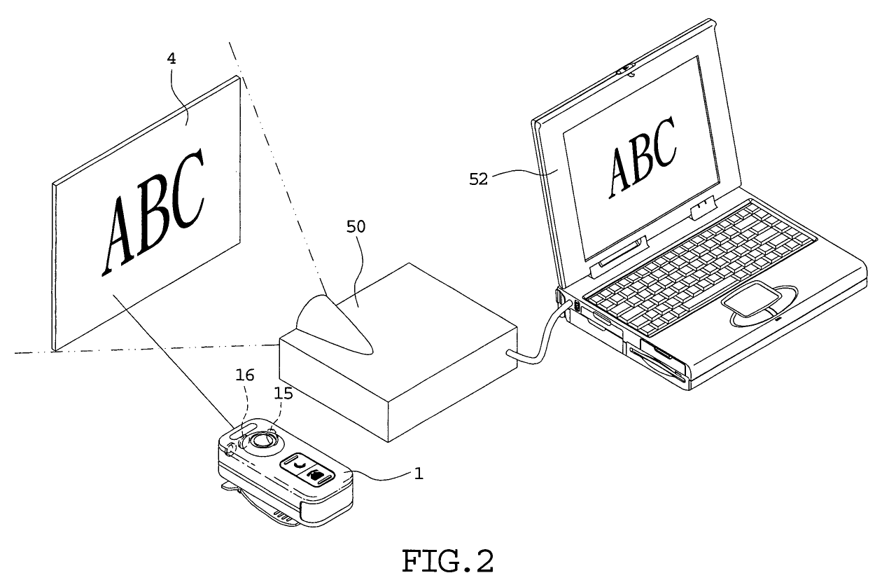

Referring to FIG. 2, a diagram of the laser indicator of the present invention is shown. Users press the button switch 15 of the wireless presentation apparatus 1 to drive the laser indicator 16, so as to emit laser beams to a remote screen 4. Then, the screen 4 displays the images projected by a projector 50 of the computer 52. Thereof, users can perform a presentation well by the wireless presentation apparatus 1 with various functions of the laser indicator 16, computer 52, and the projector 50.

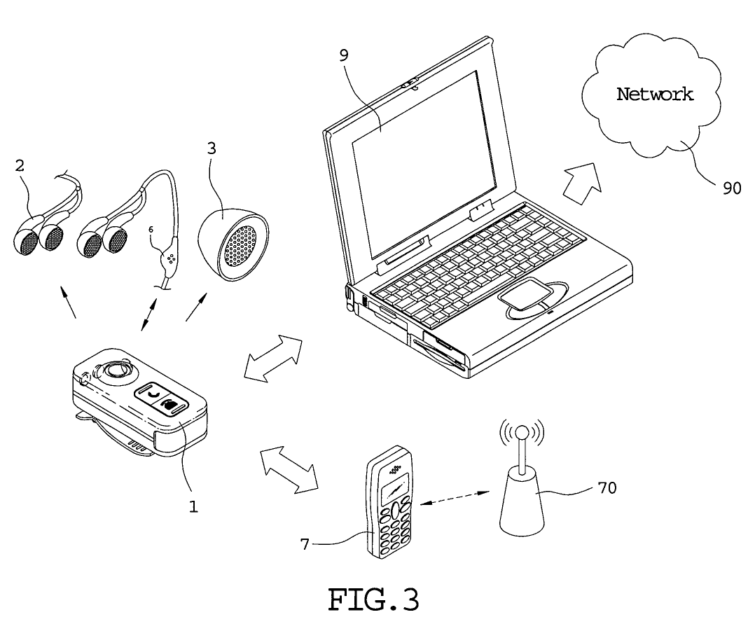

Referring to FIG. 3, a diagram of the wireless communication of the present invention is shown. The wireless presentation apparatus 1 connects with the earphone plug 2, the megaphone plug 3, or the communication plug 6 and simultaneously operates with the computer 9 and the bluetooth mobile phone 7 for further performing wireless communication. In this case of the earphone plug 2, the wireless presentation apparatus 1 can connect with the internet network 90 via the computer 9 and execute the communication software in the computer 9 for further performing the function of the wireless network communication, wherein, the communication software can be SKYPE, MSN or ICQ, etc. In this case of the communication plug 6, the wireless presentation apparatus 1 can connect with the remote base station 70 via a Bluetooth mobile phone 7 to communicate or dial, and the function is similar to general Bluetooth earphones. Moreover, in this case of the megaphone plug 3, the wireless presentation apparatus 1 can amplify audio signals received from web phones or cell phones.

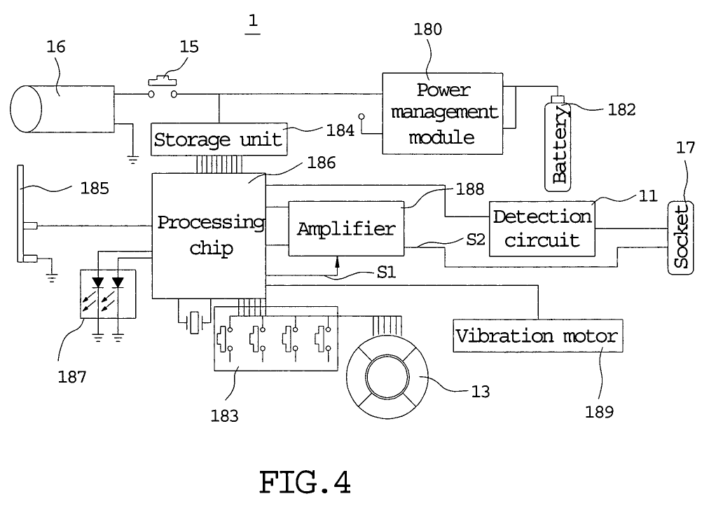

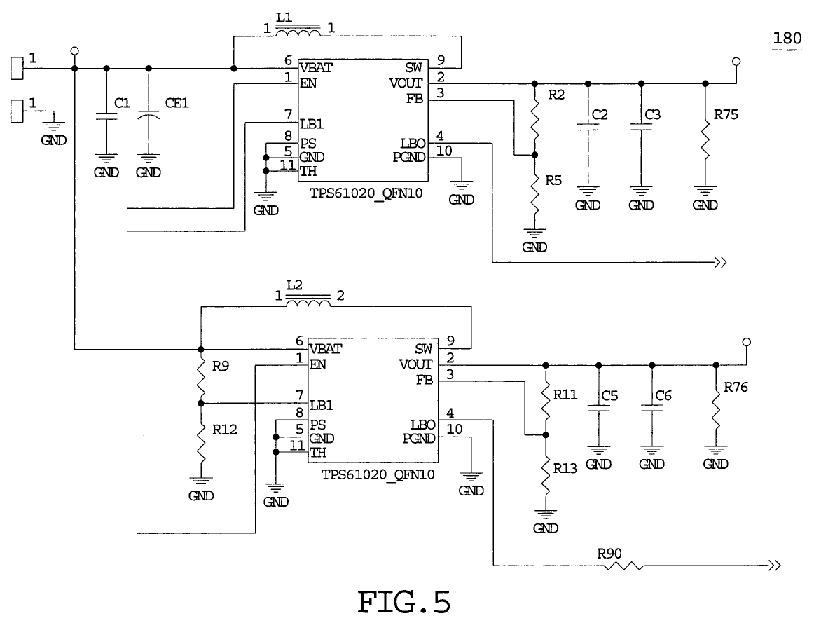

Referring to FIG. 4, a diagram of the first embodiment of the present invention is shown. The wireless presentation apparatus 1 includes the battery 182, the power management module 180, the laser indicator 16, the button switch 15, the storage unit 184, the processing chip 186, the amplifier 188, the socket 17, the detection circuit 11, a plurality of buttons 183 and the wireless receiver/transmitter 185. The wireless receiver/transmitter 185 is a antenna. In FIG. 5, a detailed circuit diagram of the power management module of the present invention is shown. The power management module 180 includes an integrated circuit TPS61020_QFN10 that connects with the components L1, L2, etc.

The power management module 180 connects with the battery 182 to supply power to the wireless presentation apparatus 1. The laser indicator 16 connects with the power management module 180 via the button switch 15 that controls the power management module 180 to supply power to the laser indicator 16 for further emitting a laser beam. The storage unit 184 stores application programs. The processing chip 186 connects with the power management module 180, the storage unit 184 and the wireless receiver/transmitter 185, and controls the movement of a cursor and the receiving or transmission of a voice and outputs an audio control signal.

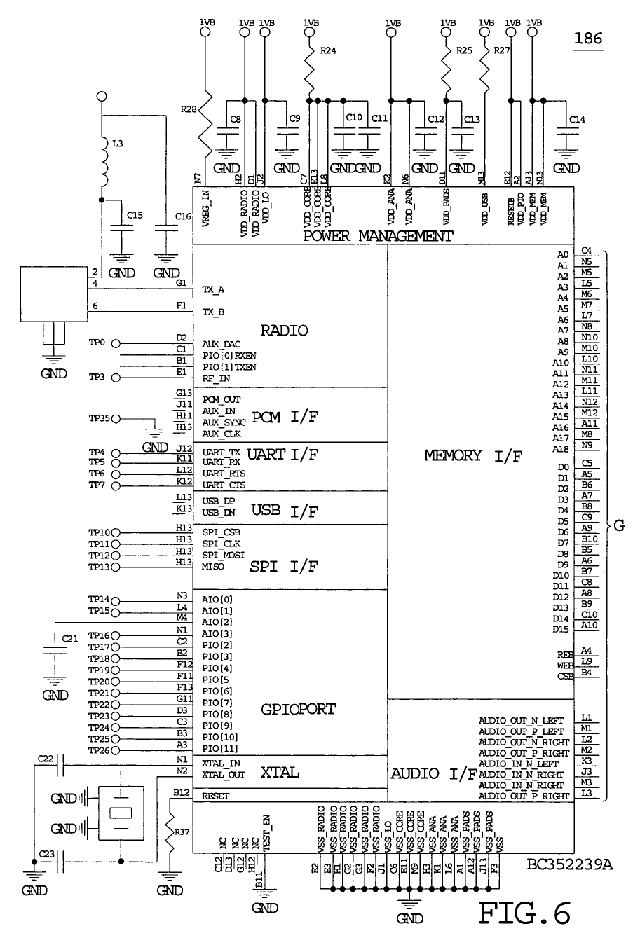

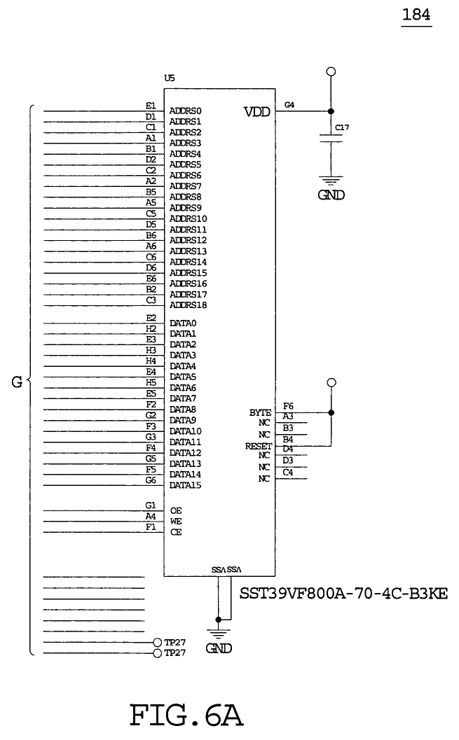

Referring to FIG. 6 and FIG. 6A, a detailed circuit diagram of the processing chip connecting with the storage unit, of the present invention is shown. The processing chip 186 is an integrated circuit BC352239 Å, and the storage unit 184 is an integrated circuit SST39VF800A-70-4C-B3KE.

When connecting with the remote electrical device (not shown) via the wireless receiver/transmitter 185, the processing chip 186 remotely controls the movement of the cursor on a computer monitor, receives messages and transmits reply messages, wherein the electrical device is a computer, and the wireless receiver/transmitter 185 is a Bluetooth wireless receiver/transmitter. When connecting with the amplifier 188, the processing chip 186 controls the amplifier 188 via an audio control signal S1 to output an amplified audio signal S2 that is produced by the processing chip 186 executing the application programs or controlling the receiving/transmission audio signals.

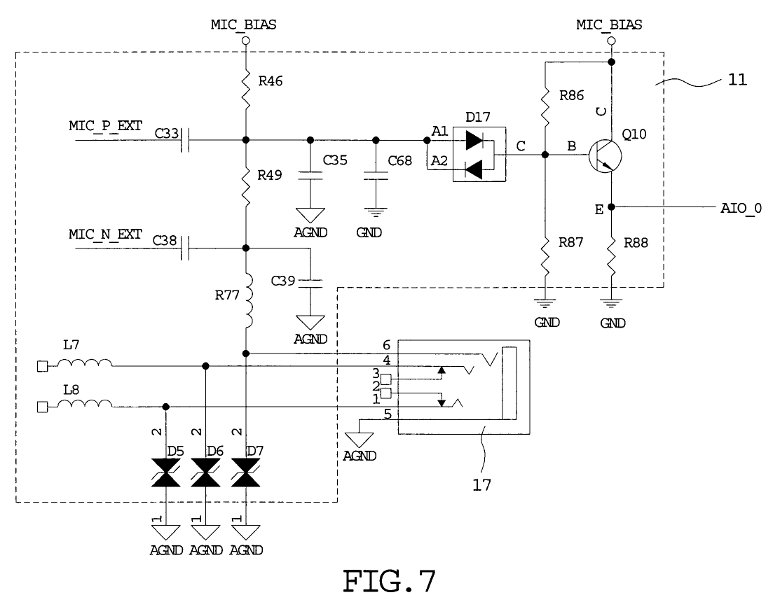

Referring to FIG. 7, a detailed circuit diagram of the detection circuit connecting with the socket, of the present invention is shown. The detection circuit 11 includes a transistor Q10, a diode D17, a resistance R46, a resistance R49, an inductor R77, etc., wherein the transistor Q10 connects with the diode D17.

When connecting with the socket 17 via the detection circuit 11, the processing chip 186 determines the type of plug plugged into the socket 17 utilizing the detection circuit 11 and transmits the amplified audio signal S2 to the socket 17 utilizing the amplifier 188 for further outputting the amplified audio signal S2 from the plug. In this case, the plug is an earphone plug, a megaphone plug or a communication plug, wherein the communication plug is an earphone or a microphone plug. All the earphone plugs and the communication plugs output stereophonic signals, and the megaphone plug outputs monophonic signals.

When the socket 17 does not connect with the plug, the diode D17 turns the transistor Q10 ON via the voltage between the resistance R46 and R49. After the transistor Q10 is turned ON, the detection circuit 11 outputs a high potential to the pin, AIO-0, of the processing chip 186 for further determining whether any plug has been plugged into the socket 17. If an earphone plug has been plugged into the socket 17, and the resistance R77 is grounded, the diode D17 will cut off the transistor Q10 via the voltage between the resistance R46 and R49. After cutting off the transistor Q10, the detection circuit 11 outputs a low potential to the pin, AIO-0, and the processing chip 186 for further determining whether any earphone plugs have been plugged into the socket 17. Similarly, the detection circuit 11 determines whether any megaphone plug or communication plug has been plugged into the socket 17.

In FIG. 1, the plurality of buttons 183 in the wireless presentation apparatus 1 connect with the processing chip 186, wherein the plurality of buttons 183 include a function key 14, a communication key 10 and a power/connecting key 12. Users can press one of the plurality of buttons 183 to control the processing chip 186 for further performing corresponding functions.

Moreover, the wireless presentation apparatus 1 further includes a vibration motor 189, an LED pilot lamp 187, and a mouse 13. The vibration motor 189 connects with the processing chip 186 and is controlled by the same for further substituting ring sounds. The LED pilot lamp 187 and the mouse 13 also connect with the processing chip 186. Users can input a cursor instruction to the processing chip 186 via the mouse 13 for further controlling the movement of the cursor on the screen of the remote computer 9 and receive reminders from the LED pilot lamp 187.

Hence, the wireless presentation apparatus 1 operates in the supply of a No. 4 battery.

An advantage of the present invention is the lowering of the operation current and the current leakage based on MOS transistors. The previous control device was designed to switch via bipolar transistors. Because the bias resistances of the bipolar transistors are about K ohm, the current depletion that occurs while the bipolar transistors are ON is more than 10 mA, and the current leakage that occurs while the bipolar transistors are OFF is more than 10 uA. However, because the bias resistances of the MOS transistors are about M ohm, the current depletion that occurs while the MOS transistors are ON is more than 10 uA, and the current leakage that occurs while the MOS transistors are OFF is more than 10 nA.

Another advantage of the present invention is the increasing of the operation voltage VDD based on the drain switch Q23, the capacitance C23, the resistance R26, and the diode D21. The previous control device stops one of the discharging paths of the capacitance C13 via the diode D11, so that the operation voltage VDD of the controller 14 is 0.4˜0.9 V less than the voltage of the battery 10 under −40˜125□. This decreases the operating life of products. However, the operation voltage VDD that the present invention provides to the controller 24 is similar to the voltage of the battery 20 under −40˜125□. This doesn't decrease the operating life of the products.

Another advantage of the present invention is the controlling of the discharging time of the capacitances for further ensuring that the self-holding circuit is turned OFF based on any load and any temperature. The previous control device discharges from the capacitance C13 into the controller 14, and the discharging time is controlled by the load of the controller 14. Designers cannot control the discharging time. If the load of the controller 14 is too large, the self-holding circuit will be not turn OFF or maintain the voltage utilizing a high power capacitance (which is not shown). However, the present invention discharges from the capacitance C23 into the resistance R26 and controls the discharging time based on the product of the capacitance C23 and the resistance R26. Thus, designers can control the discharging time based on the product of the capacitance C23 and the resistance R26 without the load and the high power capacitance.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A wireless presentation apparatus comprising:
a power management module;
a laser indicator connecting with the power management module;
a storage unit for storing application programs;
a processing chip for connecting with the power management module and the storage unit, so as to control the movement of a cursor, receive or transmit an audio signal and output an audio control signal;
an amplifier for connecting with the processing chip, so as to receive the audio control signal for further outputting the amplified audio signal;
a socket for connecting with the amplifier, so as to receive the amplified audio signal;
a detection circuit for connecting with the socket and the processing chip, wherein the processing chip connects with the socket via the detection circuit, and the processing chip determines the type of plug plugged into the socket;
a plurality of buttons for connecting with the processing chip; and
a wireless receiver/transmitter for connecting with the processing chip and an remote electronic device.

2. The wireless presentation apparatus according to claim 1, further comprising a button switch connecting with the power management module and laser indicator and controlling the power supply of the laser indicator.

3. The wireless presentation apparatus according to claim 1, further comprising a vibrating motor connecting with the processing chip.

4. The wireless presentation apparatus according to claim 1, wherein the wireless receiver/transmitter is a Bluetooth wireless receiver/transmitter.

5. The wireless presentation apparatus according to claim 1, wherein the socket is an earphone plug, and the amplified audio signal the amplifier outputs is a stereophonic signal.

6. The wireless presentation apparatus according to claim 1, wherein the socket is a megaphone plug, and the amplified audio signal the amplifier outputs is a stereophonic signal.

7. The wireless presentation apparatus according to claim 1, wherein the socket is a communication plug, and the amplified audio signal the amplifier outputs is a monophonic signal.

8. The wireless presentation apparatus according to claim 7, wherein the communication plug is a plug for an earphone and a microphone.

9. The wireless presentation apparatus according to claim 1, further comprising an LED pilot lamp connecting with the processing chip.

10. The wireless presentation apparatus according to claim 1, further comprising a mouse connecting with the processing chip.

11. The wireless presentation apparatus according to claim 1, wherein the wireless presentation apparatus operates in the supply of a No. 4 battery.
